(19) United States
(12) Patent Application Publication
(10) Pub. No.: US 2002/0135742 A1
(43) Pub. Date: Sep. 26, 2002

(54) Projector device for continuously projecting films

(76) Inventors: Kun Szu Chiang, Chong Ho City (TW); Chin Nan Lin, Chong Ho City (TW); Hsuan Chorng Chen, Chong Ho City (TW); Hung Hsuan Chen, Chong Ho City (TW)

Correspondence Address: Kun Szu Chiang, P.O. Box 10-69, Chong Ho, Taipei, 235, TW

(21) Appl. No.: 09/817,721

(22) Filed: Mar. 23, 2001

(51) Int. Cl. G03B 23/08

(52) U.S. Cl. 353/109

(57) ABSTRACT

A projector device includes a light device disposed in a housing, a camera barrel disposed in front of the light device, and a tape disposed around the light device and movable around the light device and having a portion disposed between the light device and the camera barrel for allowing the tape to be projected by the light device continuously when the tape is rotated around the light device. A motor may be used to move the tape around the light device. The housing includes a number of rods, and the tape is engaged around the rods.

### BACKGROUND OF THE INVENTION

1. Field of the Invention

The present invention relates to a projector device, and more particularly to a projector device for continuously projecting the films and/or for generating a sound or the like.

2. Description of the Prior Art

Typical projector devices comprise a film casing slidably received in a housing of the projector device for supporting a number of films and for moving the films through a projector light device step by step or one by one. However, the films may not be continuously projected or displayed by the projector device.

The present invention has arisen to mitigate and/or obviate the afore-described disadvantages of the conventional projector devices.

### SUMMARY OF THE INVENTION

The primary objective of the present invention is to provide a projector devise may be used for continuously projecting the films and/or for generating a sound or the like.

A In accordance with one aspect of the invention, there is provided a projector device comprising a housing including a rear portion and a front portion, a light device disposed in the rear portion of the housing, a camera barrel disposed in the front portion of the housing, and a tape disposed around the light device and movable around the light device and having a portion disposed between the light device and the camera barrel for allowing the tape to be projected by the light device. The tape may be rotated or moved through the projection area that is located between the light device and the camera barrel for allowing the patterns of the tape to be projected by the light device continuously or step by step.

A device may further be provided for moving the tape around the light device and includes a motor having a spindle engaged with the tape for moving the tape around the light device gradually or continuously or step by step. A control device or a processing unit may further be provided for controlling the projector device.

A number of rods may further be provided in the housing for supporting the tape which is engaged around the rods. A casing may further be provided and disposed in the housing and having the rods extended therein for supporting the tape.

The camera barrel includes at least two lenses disposed therein, and means for adjusting the lenses toward and away from each other.

One or more films may further be provided and disposed between the light device and the camera barrel for allowing the films to be projected by the light device one by one as that of the typical projector devices or apparatus.

A frame may further be provided and disposed in the housing and disposed between the light device and the camera barrel for supporting the films. The films may include different colors and/or patterns provided therein and may be changed with each other for allowing different patterns or colors to be projected alternatively or adjustably or selectively by the users. A supporting base may further be provided for supporting the housing.

Further objectives and advantages of the present invention will become apparent from a careful reading of a detailed description provided herein below, with appropriate reference to accompanying drawings.

### BRIEF DESCRIPTION OF THE DRAWING

FIG. 1 is a rear perspective view of a projector device in accordance with the present invention;

FIG. 2 is a rear perspective view similar to FIG. 1, showing the inner structure of the projector device;

FIG. 3 is a front perspective view of the projector device;

FIG. 4 is a partial perspective view showing the operation of the driving or moving device for the projector device; and

FIG. 5 is a rear perspective view illustrating the operation of the projector device.

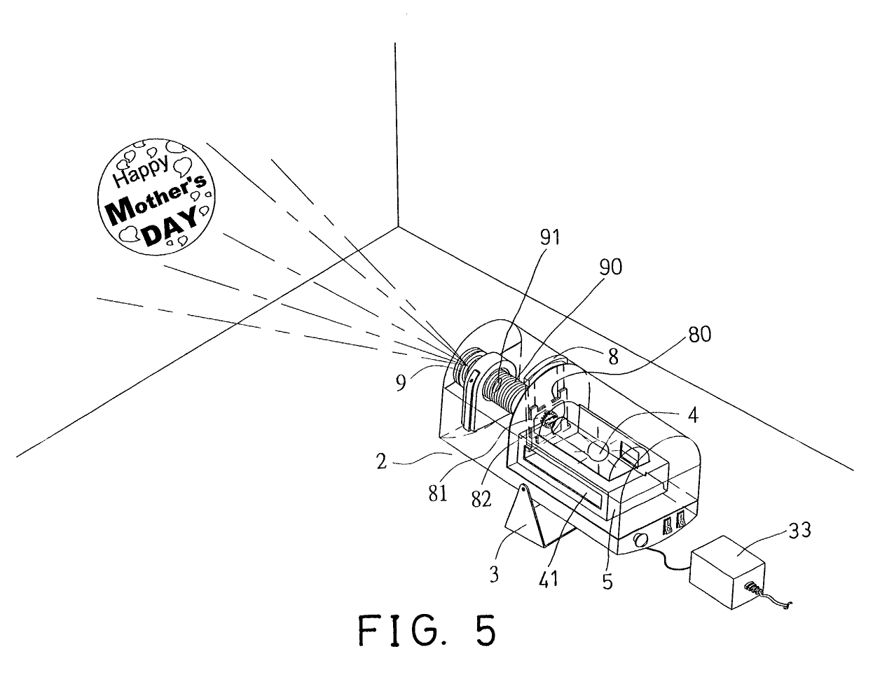

### DETAILED DESCRIPTION OF THE PREFERRED EMBODIMENT

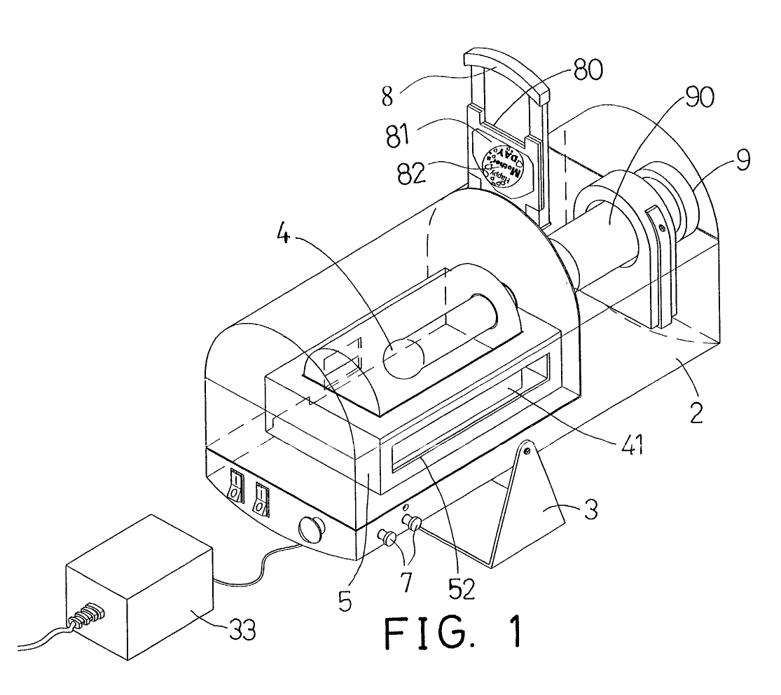

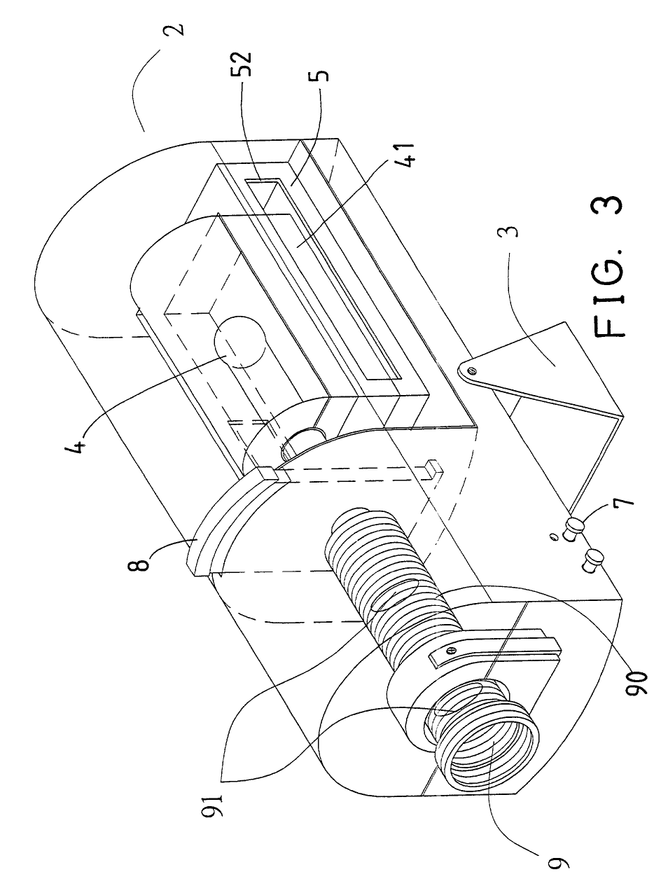

Referring to the drawings, and initially to FIGS. 1-4, a projector device in accordance with the present invention comprises a housing 2 notatably or adjustably supported on a base 3 or the like, a casing 5 is secured in the housing 2, such (as secured in the rear portion of the housing 2, and a box 41 secured in the casing 5 and having a light device 4, such as a halogen light bulb 4 or the like disposed thereon for generating a light and for film projecting purposes. The housing 2 may include one or more switch buttons 7 provided therein for controlling the projector devices for example.

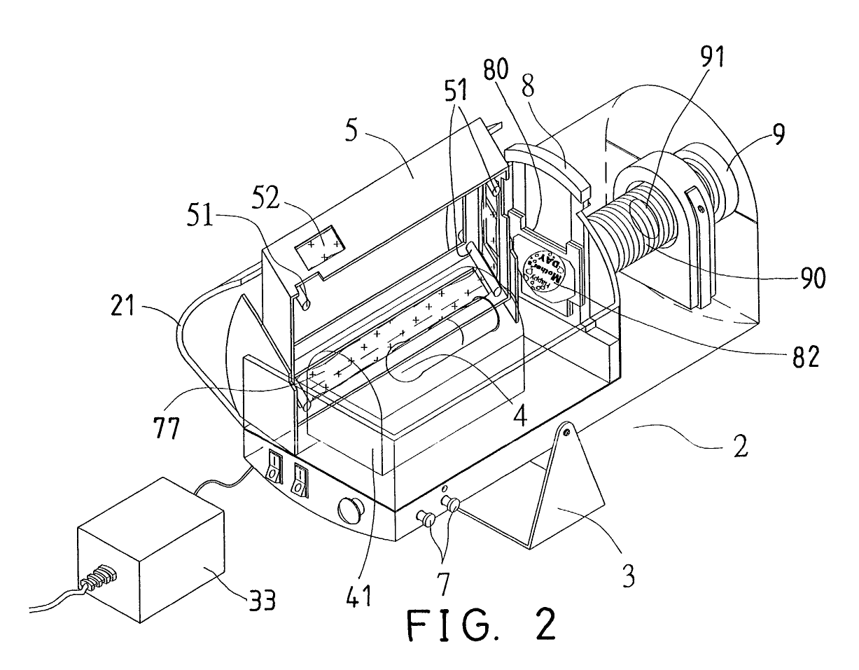

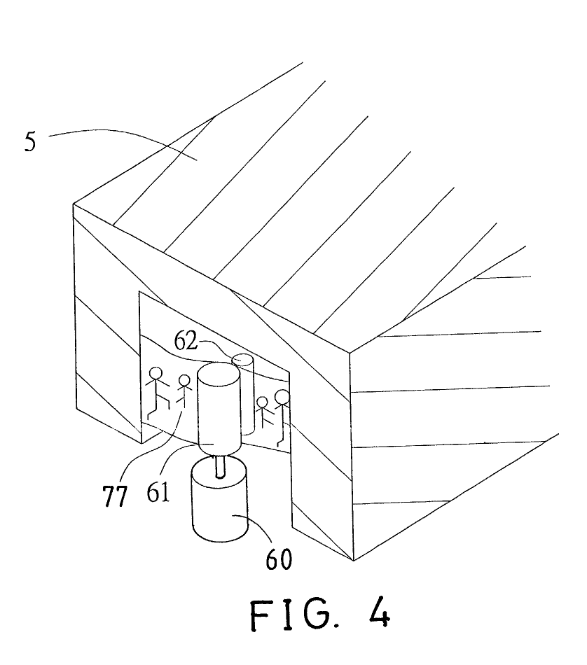

The casing 5 includes one or more rods 51 provided therein, such as includes four rods 51 provided and extended in the four corner areas thereof (FIG. 2). A film or a tape 77 to be projected is engaged around the rods 51 of the casing 5 and thus engaged around the box 41 or around the light device 4. As shown in FIG. 4, a motor 60 may include a spindle 61 engaged on one side of the tape 77, and an auxiliary roller 62 engaged on the other side of the tape 77, such that the tape 77 may be fed or rotated around the rods 51 by the motor 60. The switch buttons 7 may be used to control the motor 60, for example. The casings 5 may include one or more windows 52 (FIGS. 1-3) formed therein for allowing the film or the tape 77 to be partially seen through the windows 52 of the casing 5.

A cap or a lens holder 9 is secured in front of a camera barrel 90 which is secured in the housing 2, such as secured in the front portion of the housing 2, and which includes two or more lenses 91 disposed therein and movable toward or away from each other by the lens holder 9, in order to adjust the focus or the like. A frame S is disposed between the light device 4 and the camera barrel 90. One or more films or membranes 30, 81 may be engaged into the frame 8 and disposed between the light device 4 and the camera barrel 90 for allowing the pattern 82 applied or provided on the film 81 may be projected through the camera barrel 90 by the light device 4. The other films 80 of different colors may be changeably attached to the frame 8 for allowing different colors to be projected. A control box or a processing unit 33 may further be provided for controlling the projector device.

In operation, the film of the tape 77 may be rotated around the casing 5 or the box 41 or around the light device 4 by the motor 60, for allowing the tape 77 to be gradually moved through the projection area that is located between the light device 4 and the camera barrel 90 for allowing the colors or the pattern 82 on the films 80, 31 may be projected through the camera barrel 90 by the light device 4. The films 80, 81 may further be provided in the frame 8 and disposed in the projection area, in addition to the tape 77, or after the tape 77 has been removed, such that the projector device may be used to continuously project the patterns or the colors of the tape or of the films and/or to project the patterns or the colors of the films one by one.

Accordingly, the projector device in accordance with the present invention may be used for continuously projecting the films and/or for generating a sound or the like.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A projector device comprising:
a housing,
a light device disposed in said housing,
a tape disposed around said light device and movable around said light device for allowing said tape to be projected by said light device.

2. A projector device comprising:
a housing including a rear portion and a front portion,
a light device disposed in said rear portion of said housing,
a camera barrel disposed in slid front portion of said housing, and
a tape disposed around said light device and movable around said light device and having a portion disposed between said light device and said camera barrel for allowing said tape to be projected by said light device.

3. The projector device according to claim 2 further comprising means for moving said tape around said light device.

4. The projector device according to claim 3, wherein said moving means includes a motor having a spindle engaged with said tape for moving said tape around said light device.

5. The projector device according to claim 2 further comprising a plurality of rods provided in said housing, said tape being engaged around said rods.

6. The projector device according to claim 5 further comprising a casing disposed in said housing and having said rods extended therein for supporting said tape.

7. The projector device according to claim 2, wherein said camera barrel includes at least two lenses disposed therein, and means for adjusting said at least two lenses toward and away from each other.

8. The projector device according to claim 2 further comprising at least one film disposed between said light device and said camera barrel for allowing said at least one film to be projected by said light device.

9. The projector device according to claim 8 further comprising a frame disposed in said housing and disposed between said light device and said camera barrel for supporting said at least one film.

10. The projector device according to claim 2 further comprising means for supporting said housing.
